(19) United States
(12) Patent Application Publication
(10) Pub. No.: US 2009/0025644 A1
(43) Pub. Date: Jan. 29, 2009

(54) ANIMAL FEEDING DEVICE

(76) Inventor: Michael A Ebert, St. Marys (CA)

Correspondence Address: MICHAEL A EBERT, 17563 GREGORY DR, ST. MARYS, ON, N4X 1C6, CA

(21) Appl. No.: 11/782,930

(22) Filed: Jul. 25, 2007

(51) Int. Cl. A01K 5/00

(52) U.S. Cl. 119/61.5

(57) ABSTRACT

An animal feeding device is provided. The device comprises an open-top container to hold a portion of animal food and an obstruction for placement within the container. The obstruction is mobile within the container and sized to permit an animal to access food within the container by moving the obstruction. The device aids in slowing an animal's intake of food.

The present invention generally relates to feeding devices for animals, and in particular, relates to a feeding device that controls the speed with which an animal consumes its feed.

### BACKGROUND OF THE INVENTION

Animals, including both wild captive animals and domestic animals, are typically known to devour their food when fed. This behaviour is clearly unhealthy and can result in digestion problems, as well as potentially leading to over-eating.

To address this problem, an animal feeding dish currently exists having an integral protrusion which extends upwardly from the base on the interior of the dish. The protrusion functions to partially obstruct an animal's ready access to food in the dish, forcing the animal the work around the protrusion to obtain food and thereby slowing down their consumption of the food. Although this modified feeding dish is generally suitable for its purpose it may be difficult to clean around the protrusion.

In view of the foregoing, there remains a need to develop an improved animal feeding dish which functions to slow an animal's intake of food when feeding.

### SUMMARY OF THE INVENTION

A novel feeding device has now been developed comprising a mobile obstruction within a container. The device is effective to slow an animal's intake of food during feeding.

Thus, in one aspect of the present invention, an animal feeding device is provided comprising:

an open-top container to hold a portion of animal food; and
an obstruction within the container, said obstruction being mobile within the container and sized to permit an animal to access food within the container by moving the obstruction with a paw or muzzle.

In another aspect of the invention, a kit is provided comprising:

an obstruction sized to sit in a container suitable for use to feed an animal, said obstruction being shaped to permit an animal to move the obstruction to access food in the container.

In another aspect, there is provided a kit comprising:
a container suitable to hold a portion of animal food; and
an obstruction sized to sit in the container, said obstruction being shaped to permit an animal to move the obstruction to access food in the dish.

In another aspect, a method of feeding an animal is provided comprising the steps of:

1) placing an obstruction in a container suitable for use to feed an animal either before or after a portion of food is placed in the container, said obstruction being shaped to permit the animal to move the obstruction within the container to access food therein; and
2) offering the container to the animal.

In a further aspect, the use of an obstruction to slow an animal's intake of food during feeding is provided, wherein the obstruction is placed in an animal feeding container containing food and wherein the obstruction is movable within the container to permit the animal to move the obstruction to access the food.

These and other aspects of the invention are described by reference to the detailed description and drawings in which:

### BRIEF DESCRIPTION OF THE DRAWINGS

FIG. 1 is a perspective view of a feeding device according to an embodiment of the invention;

FIG. 2 is a perspective view of the device of FIG. 1 with animal food in it;

FIG. 3 is a side view of an embodiment including a lipped peripheral edge;

FIG. 4 (A-E) illustrates exemplary obstructions of a device according to the invention;

FIG. 5 is a side view of an embodiment in which the obstruction is fixed to the container; and

FIG. 6 illustrates a feeding device according to the invention in use.

### DETAILED DESCRIPTION OF THE INVENTION

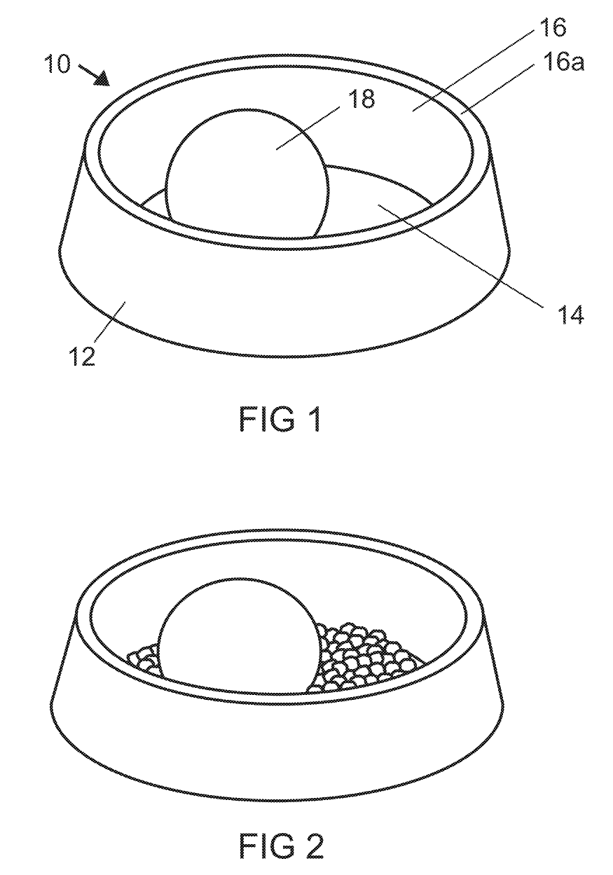

An animal feeding device as shown in FIG. 1 is provided comprising a container 12 and an obstruction 18 for placement within the container 12.

The container 12 is open-topped to allow any animal to feed therefrom and includes a cavity 14 within a peripheral edge 16 to contain animal feed as shown in FIG. 2. The container 12 may be any bowl, dish, trough or the like, not restricted with respect to shape, which is suitable for use to feed an animal. The term “animal” as used herein is meant to refer to any type of animal including domestic animals such as cats and dogs, livestock such as horses, pigs and cows, and wild animals in circumstances which require them to be fed from a container. The container 12 may be adapted, for example, to receive a lid by having threading or a lip, which extends outwardly from the cavity 14, formed at the top 16a of the peripheral edge 16.

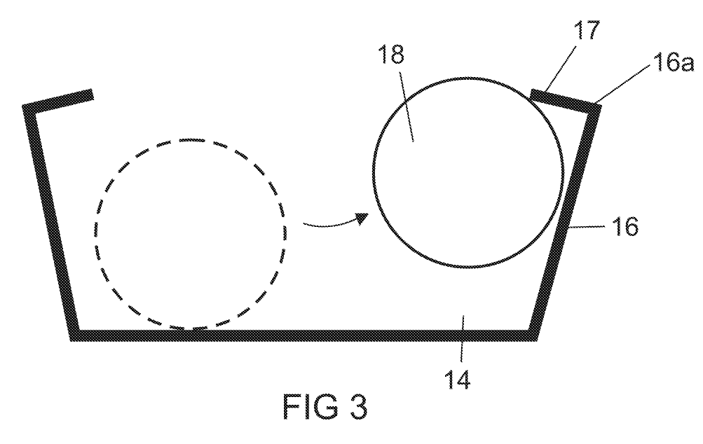

In one embodiment, as shown in FIG. 3, the peripheral edge 16 may have an inwardly extending lip 17 formed at the top 16a of the peripheral edge 16 to prevent the obstruction 18 from being pushed out of the container 12 when the animal is moving the obstruction 18 about the container during feeding.

The container 12 may be made of any material appropriate for feeding an animal, such as stainless steel, ceramic, plastic, rubber and the like; however, one of skill in the art will appreciate that containers made of certain materials may be more suitable for feeding certain animals than others. For example, containers for feeding dogs are most suitably made from stainless steel, ceramic or plastic. The size of the container is not particularly restricted, but will generally be dictated by the animal for which it is meant to feed.

The obstruction 18 is for placement within container 12 and is mobile therein. The obstruction 18 may be detached from the container 12 and freely moveable within the cavity 14 of the container 12. Thus, the obstruction 18 is sized to fit within the container 12 but may vary in size based on the size of the container 12 with which it will be coupled. Generally, the obstruction 18 will occupy 10 to 30% of the open feeding area of the container and have a diameter, or in the case of an oval-shaped obstruction, have a widest dimension, in the range of one third to one half the inside diameter/widest dimension of the feeding container.

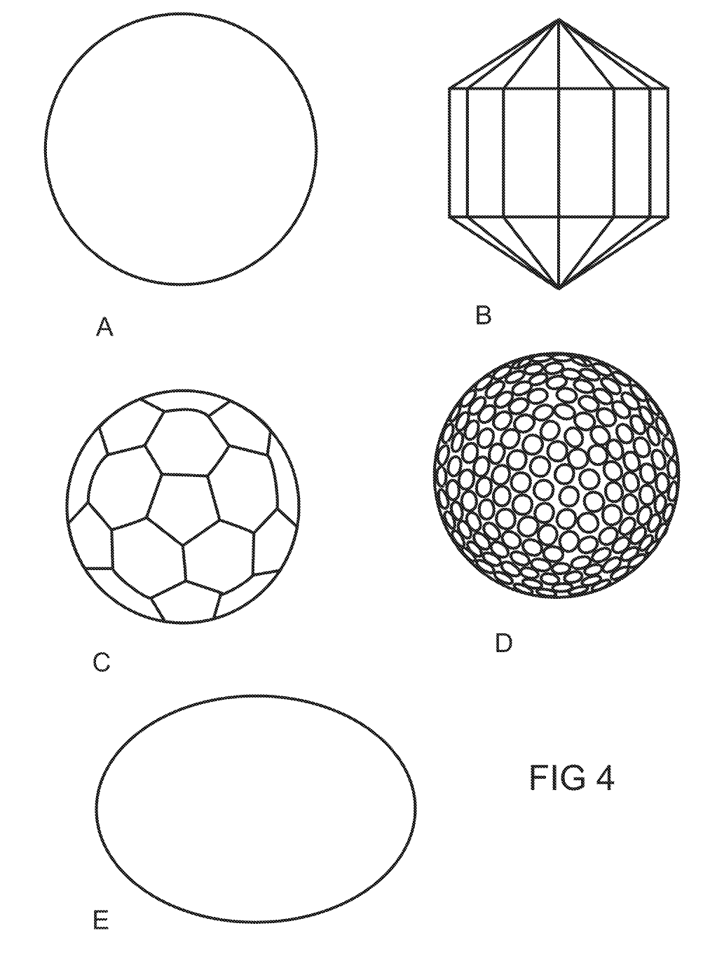

The obstruction 18 is shaped to allow it to be easily moved within the container 12 by an animal feeding from the container 12, preferably by pawing or using its muzzle. In addition, the obstruction 18 is shaped such that it does not cause any discomfort to the animal when it muzzles or paws the obstruction 18 out of the way in order access its food. Suitably shaped obstructions 18, thus, include those comprising curved surfaces that can readily be rolled out of the way by the animal as shown in FIG. 4 including spherical (A), oval and egg-shaped obstructions (C), and modified versions of each such as a spherical shape comprising multiple polygon—(B and E) or sphere-shaped (D) faces.

The obstruction 18 is generally composed of any non-toxic material which is appropriate for placement within the food of an animal. In some instances, the obstruction 18 is made out of a material that can withstand being pushed about the container 18, and perhaps also biting, nibbling or licking by an animal. Accordingly, the obstruction 18 is preferably made of a material having a hardness of at least about 40 shore D and preferably has a hardness of at least about 60, and more preferably, at least about 80 shore D. Non-limiting examples of materials from which the obstruction may be made include stainless steel, glass, ceramic, plastic, nylon, ploy carbonate, stone and composite resin. It will also be appreciated that the obstruction may be made of a combination of materials, for example a core of a filling material such as styrofoam which is coated with a material of a suitable hardness as described. Alternatively, the obstruction may be hollow.

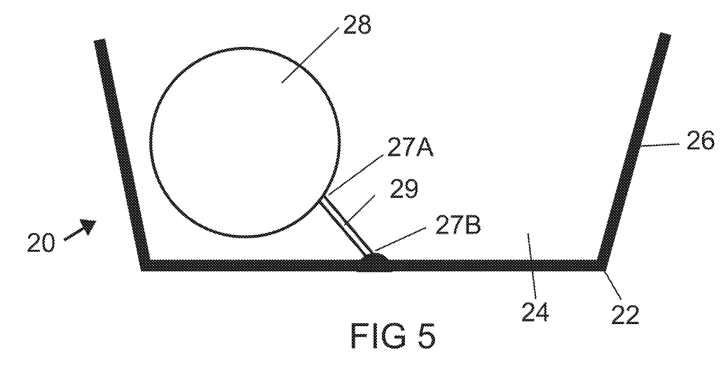

In an alternative embodiment, a device 20 is provided (as shown in FIG. 5) comprising an obstruction 28 which is fixed onto a stem 29 at the top end 27a thereof. The bottom end 27b of the stem 29 is fixed to container 22 of the device 20. The point of attachment of the stem 29 to the container 22 within cavity 24 is not particularly restricted as long as the stem 29 places the obstruction 28 appropriately for it to function as an obstruction to an animal feeding from the device 20. Thus, the bottom end 27b of the stem 29 may be attached at any point within the cavity 24 of container 22, including along the peripheral edge 26 of the container 22. In any case, the stem 29 is flexible in order that the mobility of the obstruction 28 is retained, and thus, the stem may be made of a material such as plastic, rope or rubber.

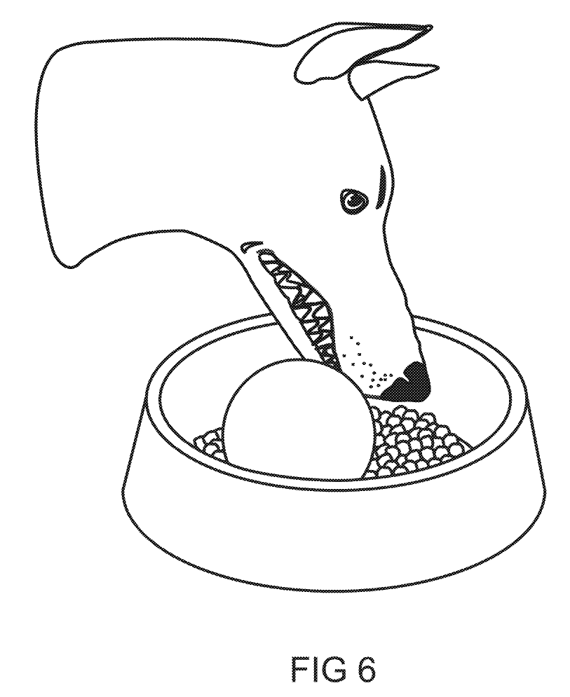

In use, the container 12 of a device such as device 10 is filled with a portion of animal food. An obstruction 18 is placed in the container 12 amongst the food and the food-filled device is offered to an animal as shown in FIG. 6. The animal can eat the food, but the process of eating is slowed as the animal must work around the obstruction 18, muzzling or pawing the obstruction 18 out of its way to access the food.

Devices according to the invention, thus, can advantageously be sued to slow the speed by which an animal consumes its food. As one of skill in the art will appreciate, the term “food” is used herein to denote any type of solid, semi-solid or liquid food, or any beverage (e.g. water, milk, and the like) that an animal may need to consume. Thus, the device is useful to slow the consumption of any such food or liquid. This provides a healthier feeding regimen for animals, particularly those known to “inhale” their food, minimizing the development of digestion difficulties.

In another aspect of the invention, a kit is provided including a suitable obstruction 18, as described, for placement in an animal feeding container. The kit may additionally include instructions for the use of the obstruction 18 to feed an animal, indicating that the obstruction is to be placed within the container amongst the animal food and then offered to the animal at feeding time. The kit may also include a suitable feeding container 12 of an appropriate size for use with the obstruction 18 as described above.

A method of feeding an animal is also provided. The method includes placing a suitable obstruction, in terms of shape, size and hardness, in a container appropriate for use to feed an animal. A portion of animal food is put in the container, either before or after the obstruction is placed therein, and then the container is offered to the animal.

Thus, a use of an obstruction in an animal feeding dish to slow an animal's intake of food during feeding is provided. The obstruction is placed in an animal feeding container containing food. As described, the obstruction is movable within the container and permits the animal to move the obstruction to access the food. This process of moving the obstruction during feeding functions to slow the animal's feeding, providing healthier feeding.

The foregoing description relates to certain embodiments of the invention; however, as one of skill in the art will appreciate, other embodiments may exist which fall within the scope of the appended claims.

We claim:

1. An animal feeding device comprising:
an open-top container suitable to hold a portion of animal food; and
an obstruction within the container, said obstruction being mobile within the container and sized to permit an animal to access food within the container by moving the obstruction.

2. A device as defined in claim 1, wherein the obstruction comprises a shape having curved surfaces.

3. A device as defined in claim 2, wherein the obstruction comprises a shape selected from the group consisting of a sphere, an oval, egg-shaped and modified versions of any of these comprising multiple polygon faces.

4. A device as defined in claim 1, wherein the obstruction is made of a material having a hardness of at least about 40 shore D.

5. A device as defined in claim 4, wherein the obstruction is made of a material selected from the group consisting of stainless steel, ceramic and glass.

6. A device as defined in claim 1, wherein the obstruction is attached to the container.

7. A kit comprising:
a container suitable to hold a portion of animal food; and
an obstruction sized to sit in the container, said obstruction being shaped to permit an animal to move the obstruction to access food in the dish.

8. A kit as defined in claim 7, wherein the obstruction comprises a shape having one or more curved surfaces.

9. A kit as defined in claim 8, wherein the obstruction comprises a shape selected from the group consisting of a sphere, an oval, egg-shaped and modified versions of any of these comprising multiple polygon faces.

10. A kit as defined in claim 7, wherein the obstruction is made of a material having a hardness of at least about 40 shore D.

11. A kit as defined in claim 10, wherein the obstruction is made of a material selected from the group consisting of stainless steel, ceramic and glass.

12. A kit as defined in claim 7, additionally comprising instructions for the use of the obstruction in the container.

13. A kit comprising:
an obstruction sized to sit in a container suitable for use to feed an animal, said obstruction being shaped to permit an animal to move the obstruction to access food in the container.

14. A kit as defined in claim 13, wherein the obstruction is made of a material having a hardness of at least about 40 shore D.

15. A kit as defined in claim 14, wherein the obstruction is made of a material selected from the group consisting of stainless steel, ceramic and glass.

16. A kit as defined in claim 13, additionally comprising instructions for the use of the obstruction in the container.

17. A method of feeding an animal comprising the steps of:
1) placing an obstruction in a container suitable for use to feed an animal either before or after a portion of food is placed in the container, said obstruction being shaped to permit the animal to move the obstruction within the container to access food therein; and
2) offering the container to the animal.

18. A method as defined in claim 17, wherein the obstruction comprises a shape selected from the group consisting of a sphere, an oval, egg-shaped and modified versions of any of these comprising multiple polygon faces.

19. A method as defined in claim 17, wherein the obstruction is made of a material having a hardness of at least about 40 shore D.

20. The use of an obstruction to slow an animal's intake of food during feeding, wherein the obstruction is placed in an animal feeding container containing food and wherein the obstruction is movable within the container to permit the animal to move the obstruction to access the food.
